(19) United States
(12) Patent Application Publication
(10) Pub. No.: US 2009/0231677 A1
(43) Pub. Date: Sep. 17, 2009

(54) Variable Focal Point Optical Assembly Using Zone Plate and Electro-Optic Material

(75) Inventors: Yeonjoon Park, Yorktown, VA (US); Sang H. Choi, Poquoson, VA (US); Glen C. King, Yorktown, VA (US); James R. Elliott, Yorktown, VA (US)

Correspondence Address: NATIONAL AERONAUTICS AND SPACE ADMINISTRATION;LANGLEY RESEARCH CENTER, MAIL STOP 141, HAMPTON, VA, 23681-2199, US

(73) Assignee: USA as represented by the Administrator of the National Aeronautics and Space Administration, Washington, DC (US)

(21) Appl. No.: 12/047,465

(22) Filed: Mar. 13, 2008

(51) Int. Cl. G02F 1/29

(52) U.S. Cl. 359/319

(57) ABSTRACT

An optical assembly includes a zone plate and electro-optic material disposed on one side of the zone plate. The electro-optic material's index of refraction is controlled to adjust the optical properties of the optical assembly.

### ORIGIN OF THE INVENTION

The invention was made in part by employees of the United States Government and may be manufactured and used by or for the Government of the United States of America for governmental purposes without the payment of any royalties thereon or therefor.

### BACKGROUND OF THE INVENTION

1. Field of the Invention

This invention relates to variable focal point optical assemblies. More specifically, the invention is an optical assembly having a variable focal point where the assembly includes a zone plate and electro-optical material.

2. Description of the Related Art

As illustrated in a plan view in FIG. 1, a conventional optical zone plate 10 is a planar arrangement of concentric, spaced-apart opaque rings (e.g., four rings 13, 15, 17, 19) centered on an opaque central circular region 11. The resulting ring-shaped regions (e.g., regions 12, 14, 16, 18) between the opaque rings are transparent to light. Light impinging on one face of zone plate 10 passes through the transparent ring-shaped regions to form Fresnel diffraction patterns. As is known in the art, the Fresnel diffraction patterns constructively interfere at fixed, spaced-apart locations along an axis extending perpendicularly from the central portion of zone plate 10. Accordingly, zone plate 10 essentially provides a fixed-focus lens effect. To change the focus points, some type of positioning mechanism is required to either move the light source generating the light impinging on the zone plate, the zone plate, or both.

### SUMMARY OF THE INVENTION

Accordingly, it is an object of the present invention to provide a variable-focal-point optical assembly using a zone plate.

Another object of the present invention is to provide a variable-focal-point optical assembly based on a zone plate that does not require the use of any moving parts or assemblies.

Other objects and advantages of the present invention will become more obvious hereinafter in the specification and drawings.

In accordance with the present invention, an optical assembly includes a zone plate having concentric spaced-apart rings of opaque material. Between the opaque rings, light is transmitted through the zone plate. Electro-optic material is disposed on one side of the zone plate. Coupled to the electro-optic material is the means to control an index of refraction thereof.

### BRIEF DESCRIPTION OF THE DRAWINGS

FIG. 1 is a plan view of a conventional optical zone plate;

FIG. 2 is a cross-sectional schematic view of a variable-focal-point optical assembly in accordance with an embodiment of the present invention

FIG. 3 is a cross-sectional view of a variable-focal-point optical assembly in accordance with another embodiment of the present invention;

FIG. 4 is a cross-sectional view of a variable-focal-point optical assembly in accordance with yet another embodiment of the present invention; and

FIG. 5 is an isolated schematic view of a multi-layer electro-optic material arrangement in accordance with an embodiment of the present invention.

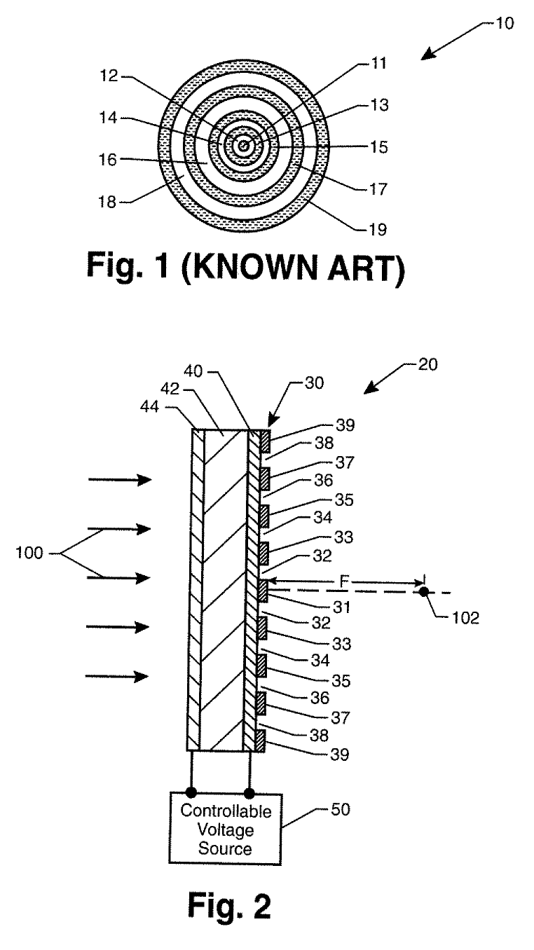

### DETAILED DESCRIPTION OF THE INVENTION

Referring again to the drawings and more particularly to FIG. 2, an optical assembly in accordance with an embodiment of the present invention is shown and is referenced by numeral 20. In general, optical assembly 20 is controllable/programmable in terms of the assembly's focal point when light passes therethrough. Thus, optical assembly 20 can be incorporated as a sub-assembly in a variety of optical systems such as a programmable micro-lens and a programmable micro-spectrometer. Accordingly, it is to be understood that the ultimate end use of optical assembly 20 is not a limitation thereof.

Optical assembly 20 includes a zone plate 30 that is defined by a planar arrangement of concentric and spaced-apart opaque rings as is known in the art. In the illustrated embodiment, zone plate 30 has a circular and opaque central region 31 and four concentric and spaced-apart rings 33, 35, 37 and 39 to thereby define four concentric and spaced-apart transparent ring regions 32, 34, 36, and 38. It is to be understood that this pattern (i.e., starting with opaque central region 31) could be reversed (i.e., starting with a transparent central region) without departing from the scope of the present invention. In addition, the number of opaque rings/transparent ring regions is not a limitation of the present invention. Still further, the size and spacing used for zone plate 30 can be tailored for a particular application without departing from the scope of the present invention.

Disposed adjacent to one face of zone plate 30 is an optically transparent electrode 40 (e.g., made from a material such as indium tin oxide or zinc oxide). Adjacent and coupled to electrode 40 is a planar face of one or more layers/types of an electro-optic material 42. Electro-optic material 42 is any of a variety of materials that can experience a change in refractive index or absorption coefficient by one or multiples in the presence of an applied electric field, current, or magnetic field. Choices for electro-optic material 42 include, but are not limited to, non-linear optical crystals, ferroelectric materials, piezoelectric materials, electro-active polymers, and liquid crystals.

Adjacent and coupled to the opposing planar face of electro-optic material 42 is another optically transparent electrode 44. The combination of electrode 40, material 42 and electrode 44 span an area that, at a minimum, covers the area defined by transparent ring regions 32, 34, 36, and 38. In the illustrated embodiment, the combination of electrode 40, material 42 and electrode 44 span the entire area defined by zone plate 30. Although not shown, the above-described assembly can be fabricated on a rigid and transparent substrate such as glass, quartz or sapphire.

A controllable voltage source 50 is electrically coupled to electrodes 40 and 44. When a voltage is applied to electrodes 40 an 44, an electric field is developed across electro-optic material 42. The electric field causes a circular gradient refractive index zone to be formed inside electro-optic material 42. This gradient refractive index changes the phase of photons of light 100 passing therethrough thereby changing the focal point 102 of light 100 passing through optical assembly 20. The focal distance F is controlled by the electric field in electro-optic material 42.

By itself, a zone plate is known to have a strong dispersion relation with the wavelength of light passing therethrough. Therefore, conventional zone plates can only serve as a focusing element with a specific monochromatic wavelength. However, in the optical assembly of the present invention, the circular gradient refractive index caused by the applied electric field also changes the properties (i.e., focal point at a specific wavelength, distribution of intensity of passing photons, and phase of passing photons) of the zone plate such that the zone plate can be optimized for a new wavelength. Thus, the present invention can also be used to control the designated wavelength of operation by controlling the electric field in the electro-optic material.

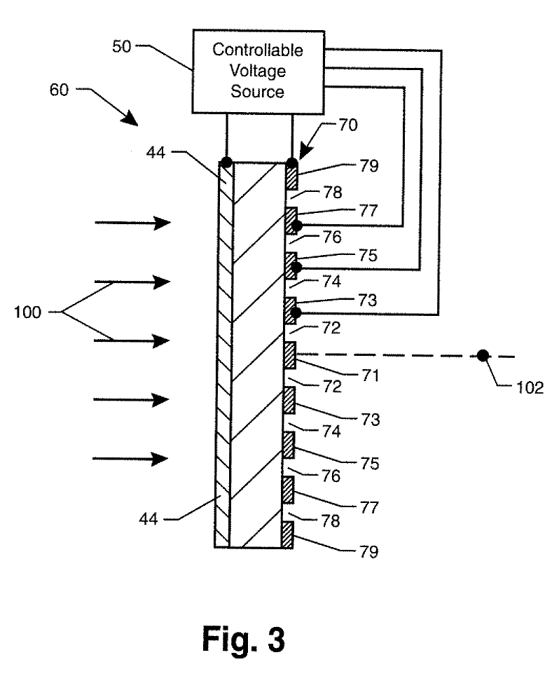

The present invention is not limited to the optical assembly construction illustrated in FIG. 2. For example, another embodiment of the present invention is illustrated in FIG. 3 where optical assembly 60 includes a zone plate 70 whose opaque central region 71 and concentric, spaced-apart opaque rings 73, 75, 77, and 79 are made from an electrically conductive material (e.g., a metal). Electro-optic material 42 is adjacent and coupled to one face of zone plate 70 while transparent electrode 44 is adjacent and coupled to the opposing face of electro-optic material 42 as in the previous embodiment. In this embodiment, controllable voltage source 50 is electrically coupled to each ring of zone plate 70 and transparent electrode 44. The applied voltages can be the same or different to suit a particular application.

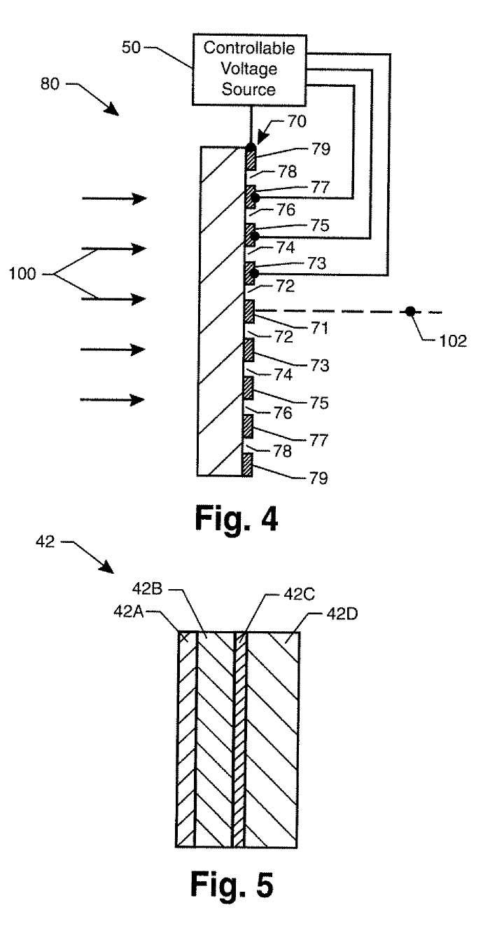

Still another embodiment of the present invention is illustrated in FIG. 4 where optical assembly 80 includes a zone plate 70 whose opaque central region 71 and concentric, spaced-apart opaque rings 73, 75, 77, and 79 are made from an electrically conductive material (e.g., a metal). Electro-optic material 42 is adjacent and coupled to one face of zone plate 70. In this embodiment, controllable voltage source 50 is electrically coupled only to each ring of zone plate 70. That is, the rings of zone plate 70 define the electrodes for optical assembly 80. The applied voltages between rings will be different to generate an electric field in electro-optic material 42.

As mentioned briefly above, electro-optic material 42 can be realized by a single homogeneous layer of electro-optic material or multiple distinct layers of electro-optic material with each of such layers having unique electro-optic properties. For example, as shown in FIG. 5, electro-optic material 42 could comprise distinct layers 42A-42D of different electro-optic materials. Further, as illustrated, the thickness of the various layers can be different to satisfy particular application requirements. Still further, the same or unique voltages could be applied to the various electro-optic material layers in order to fine tune the wavelength of operation and/or focal point positioning. Accordingly, it is to be understood that the particular choice of electro-optic material(s) and arrangement thereof are not limitations of the present invention.

The advantages of the present invention are numerous. The optical assembly can be adjusted in terms of focal point location without the use of any moving parts. The assembly can be used in a neutral state (i.e., no voltage applied) to provide a fixed focal point for a specific wavelength of operation. However, the assembly can also be used in an active state (i.e., voltage applied) to adjust the wavelength of operation and/or the location of the assembly's focal point. The optical assembly can function as a programmable micro-lens whose focal distance changes with the applied voltage. The optical assembly can also form part of a micro-spectrometer that transmits a specific wavelength of light to a photo-detector where the specific wavelength is controlled by the applied voltage.

Although the invention has been described relative to a specific embodiment thereof, there are numerous variations and modifications that will be readily apparent to those skilled in the art in light of the above teachings. For example, the controllable voltage source could be replaced with a controllable current or magnetic field source without departing from the scope of the present invention It is therefore to be understood that, within the scope of the appended claims, the invention may be practiced other than as specifically described.

What is claimed as new and desired to be secured by Letters Patent of the United States is:

1. An optical assembly, comprising:
a zone plate defining first ring-shaped regions interleaved with second ring-shaped regions, said first ring-shaped regions being optically transparent with respect to light at one or more wavelengths of interest and said second ring-shaped regions being optically opaque with respect to the light;
electro-optic material disposed on one side of said zone plate over an area that encompasses at least said first ring-shaped regions; and
means for controlling an index of refraction of said electro-optic material.

2. An optical assembly as in claim 1 wherein said zone plate further includes a central circular region that is transparent with respect to the light.

3. An optical assembly as in claim 1 wherein said zone plate further includes a central circular region that is opaque with respect to the light.

4. An optical assembly as in claim 1 wherein said electro-optic material comprises a single homogeneous layer.

5. An optical assembly as in claim 1 wherein said electro-optic material comprises multiple layers.

6. An optical assembly as in claim 5 wherein said multiple layers possess dissimilar electro-optic properties.

7. An optical assembly as in claim 1 wherein said means comprises:
first and second optically transparent electrodes sandwiching said electro-optic material; and
a controllable voltage source coupled to said first and second transparent electrodes.

8. An optical assembly as in claim 7 wherein each of said first and second transparent electrodes is selected from the group consisting of indium tin oxide and zinc oxide.

9. An optical assembly as in claim 1 wherein said zone plate is made from an electrically-conductive material coupled to said electro-optic material, and wherein said means comprises:
a transparent electrode coupled to said electro-optic material wherein said electro-optic material is disposed between said zone plate and said transparent electrode; and
a controllable voltage source coupled to said transparent electrode and said zone plate.

10. An optical assembly as in claim 9 wherein said transparent electrode is selected from the group consisting of indium tin oxide and zinc oxide.

11. An optical assembly as in claim 1 wherein said zone plate is made from an electrically-conductive material coupled to said electro-optic material, and wherein said means comprises a controllable voltage source coupled to said zone plate.

12. An optical assembly, comprising:
a zone plate including concentric spaced-apart rings of opaque material wherein, between said rings, light is transmitted through said zone plate;
electro-optic material disposed on one side of said zone plate; and
means for controlling an index of refraction of said electro-optic material.

13. An optical assembly as in claim 12 wherein said zone plate further includes a central circular region that is transparent with respect to light.

14. An optical assembly as in claim 12 wherein said zone plate further includes a central circular region that is opaque with respect to light.

15. An optical assembly as in claim 12 wherein said electro-optic material comprises a single homogeneous layer.

16. An optical assembly as in claim 12 wherein said electro-optic material comprises multiple layers.

17. An optical assembly as in claim 16 wherein said multiple layers possess dissimilar electro-optic properties.

18. An optical assembly as in claim 12 wherein said means comprises:
first and second optically transparent electrodes sandwiching said electro-optic material; and
a controllable voltage source coupled to said first and second transparent electrodes.

19. An optical assembly as in claim 18 wherein each of said first and second transparent electrodes is selected from the group consisting of indium tin oxide and zinc oxide.

20. An optical assembly as in claim 12 wherein said zone plate is made from an electrically-conductive material coupled to said electro-optic material, and wherein said means comprises:
a transparent electrode coupled to said electro-optic material wherein said electro-optic material is disposed between said zone plate and said transparent electrode; and
a controllable voltage source coupled to said transparent electrode and said zone plate.

21. An optical assembly as in claim 20 wherein said transparent electrode is selected from the group consisting of indium tin oxide and zinc oxide.

22. An optical assembly as in claim 12 wherein said zone plate is made from an electrically-conductive material coupled to said electro-optic material, and wherein said means comprises a controllable voltage source coupled to said zone plate.
